(19) United States
(12) Patent Application Publication
(10) Pub. No.: US 2015/0173304 A1
(43) Pub. Date: Jun. 25, 2015

(54) Modular Aquaponics System

(71) Applicants: Colle W. Davis, Cape Coral, FL (US); Phyllis Estes Davis, Cape Coral, FL (US); Phillip Steven Estes, Olathe, KS (US)

(72) Inventors: Colle W. Davis, Cape Coral, FL (US); Phyllis Estes Davis, Cape Coral, FL (US); Phillip Steven Estes, Olathe, KS (US)

(21) Appl. No.: 14/139,905

(22) Filed: Dec. 24, 2013

(51) Int. Cl. A01G 9/02; A01K 63/04; A01G 27/00; A01K 63/00

(52) U.S. Cl. CPC A01G 9/02; A01K 63/003; A01K 63/047; A01G 27/008

(57) ABSTRACT

The invention provides an improved modular aquaponics system for growing plants and fish together in a closed system whereby fish tank waste water is utilized by the plants as a source of fertilizer, thereby clarifying the water before returning it to the fish tank. The improvements comprise an improved plant grow tray, a prefabricated, “snap-together” grow tray system, an energy-efficient calibrated air displacement pump and a fish waste water clarifier having a baffle.

### BACKGROUND OF THE INVENTION

The present invention relates to agriculture and, more particularly, to the farming of aquatic animals and the use of their waste as fertilizing nutrients to grow vegetables in a closed loop re-circulating system.

In the twenty-first century, the world faces an environmental crisis, issues related to climate change (drought and flooding as well as record-setting heat waves) and an energy crisis. In addition, many parts of the world face severe food shortages. Twentieth century agricultural techniques have harmed the environment and consume an inordinate amount of energy and water. Many countries lack the large amounts of arable land and water needed to sustain growing human populations. Developed nations use large amounts of pesticides and artificial fertilizers to grow their grains, fruits, and vegetables. At the same time, they use huge amounts of gasoline and diesel fuel to power their farm machinery, large amounts of electricity to process their food, and enormous amounts of fuel to deliver the processed food to grocery stores. The raising of farm animals, particularly cattle and swine, is notoriously inefficient in terms of the amount of land and energy required to raise corn and other animal feed for each pound of protein produced.

UN reports tell us that in 2012, for the 6^{th} time in an eleven-year span, the world will eat more food than it produces. With 7 billion people in the world now and the expanding population growth of the projected 9.3 billion in 2050, there must be a shift towards vegetarianism and the option for farm-raised fish as a protein source for many, and a shift away from meat heavy diets, but this will take time. Growing crops to feed cattle, pigs, lamb or sheep take up more land and emit more greenhouse gases than producing crops for direct human consumption. In the 21^{st} Century, food production accounts for up to 29 percent of man-made greenhouse gasses; twice the amount the United Nations has estimated comes from traditional ‘dirt’ methods of farming.

Many areas of the world, such as California, require elaborate and expensive aqueducts and irrigation systems to deliver potable water to farming regions. A tremendous amount of fresh water evaporates or is otherwise wasted with conventional farming methods. Third world countries often lack the financial resources, arable land and technology to produce sufficient food, and in particular enough protein to maintain the health of their human populations. There are also health concerns raised by humans consuming pesticide residues on fruits and vegetables and hormones in chicken, pork and beef. Wild birds and animals are adversely affected by pesticide and fertilizer. Local waters (ponds, rivers, and streams) are also polluted by the runoff from the pesticides and fertilizers used for local growing.

Therefore, there is a need to promote a new “green” method of farming around the world for ‘locally grown food’ in any region to produce healthier food that requires far less land and water, and at the same time, is environmentally friendly:
Eliminates the need or use of artificial chemicals
Provides sustainability for people locally
Substantially reduces energy consumption for planting, harvesting and shipping food, and greenhouse gas emissions.
Also, provides jobs for local people strengthening the local economy.

Aquaponics has been explored for several decades as a possible solution to the foregoing environmental, energy and food shortage problems. Aquaponics combines the art of growing aquatic animals (fish), known as aquaculture, with the modern technology of hydroponics in which plants are grown without soil. In aquaponics, fish and plants are grown together in an integrated closed loop re-circulating system with a very low rate of water usage or water loss due to evaporation. The fish waste (effluent) produced by the fish is delivered from the fish tank to a settling tank to remove the heavy ‘waste’ and then sent to the grow trays to provide a food source for growing plants in the gravel and the plants provide a natural filter for the water that keeps the fish healthy. This symbiotic relationship between the fish and the growing plants is the goal of aquaponics by creating a sustainable ecosystem in which both fish and plants can thrive and as a result, produces safe, fresh protein and healthy vegetables.

Aquaponics systems heretofore developed have not met with widespread success. Previously, aquaponics systems have been complex and labor intensive to operate, difficult to construct because to date, there has been no standard design that has proven itself to be easy to operate, and they are often poorly constructed with inferior materials requiring constant attention to leaks, challenges for disposal of the fish waste, and careful maintenance of pH levels, micronutrient depletion and water temperature. They have also been expensive in terms of the pumps and other electrical equipment required. In addition, prior aquaponics systems have been difficult to maintain and are prone to catastrophic system failures such as death of the fish and plants due to design flaws in the actual aquaponics system.

### BRIEF SUMMARY OF THE INVENTION

The present invention provides improvements to prior aquaponics systems which have been fraught with fragility and difficulty in maintaining a healthy balance between each of the components and the living systems. In particular, the present invention improves waste removal from the aquaponics system, provides an improved pump to the aquaponics system, provides an improved grow tray design, an improved snap together design feature and uses less power than existing aquaponics systems.

Overview of the Modular Aquaponics System

The fish tank of the Modular Aquaponics System contains the water and the fresh-water fish which provides the nutrient-laden waste water for the growth of the plants in the grow tray. Periodically, a portion of the water is removed from the fish tank by the use of a uniquely designed submersed air-powered pump and transported via pipes to a clarifier located above the fish tank. Lifting the water from the fish tank to the clarifier is the only time energy is required to move water in the Modular Aquaponics System and gravity powers the remainder of the water-flow cycle. After the water has been delivered to the clarifier, the solid waste then settles to the bottom of the clarifier due to dramatic reduction in the velocity of the water flowing into the clarifier. The water overflowing out from the clarifier is free of the solid waste matter and flows from the top of the clarifier through a conduit pipe to the head of the grow tray. This clarified water is now distributed through a spreader under the gravel at the head of the grow tray to fill the grow tray to a predetermined level (much like a bathtub, it rises evenly across the entire tray). Once this predetermined water level has been attained, an automatic valve assembly under the gravel in the grow tray allows the water to completely drain from the grow tray and return to the fish tank stripped of the nutrient load by the plants and re-oxygenated by the large surface area of the gravel and leaving the plant roots exposed to the ambient air for maximum growth.

Before explaining the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The Modular Aquaponics System of the present invention is for high intensity food production involving the farming of aquatic animals and the use of their waste to grow vegetables in a closed loop re-circulating system. The Modular Aquaponics System requires no chemical fertilizers or insecticides in the growing of the food. The Modular Aquaponics System of the present invention eliminates the possibility of catastrophic system shut down because there is no single point failure in the system. The system begins to provide healthy produce approximately forty days after installation. Moreover, the Modular Aquaponics System provides a protein source (fish) within seven to nine months after the system is operational. In one embodiment, the Modular Aquaponics System is capable of feeding eight people with the labor of one person working only 20 minutes per day. Such a Modular Aquaponics System requires only 1 kwh per day of electricity (powered by any available electrical source), per module which feeds eight people. In another embodiment the Modular Aquaponics System is capable of feeding 240 people with the labor of three people working full time. The Modular Aquaponics System uses a minimal amount of potable water for food production (the water requirement is reduced by 90 to 95% compared with conventional farming). The Modular Aquaponics System is capable of providing fresh locally grown food and food security for families, groups, and cities. The Modular Aquaponics System can provide local jobs for semi-skilled labor. In addition, Modular Aquaponics Systems can be easily shipped anywhere in the world and be assembled and operated by semi-skilled labor. The Modular Aquaponics Systems can be assembled and operated as a carbon negative installation.

Objects and advantages of the present invention will become apparent to the reader and it is intended that these objects and advantages are within the scope of the present invention. This invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein.

FIG. 1 is a side view of an automatic trip valve assembly 48 of the present invention. An automatic trip valve/self-siphoning device assembly 48 is provided for conveniently draining water from the grow tray 600 upon the water in the tray reaching a predetermined level.

FIG. 2 is a side view of a calibrated air displacement pump 47 of the present invention. The calibrated air displacement pump 47, as shown in FIGS. 2, 2A and 2B, is an air-powered submersible water pumping system used to remove fish waste from the fish tank 46 to move it to the clarifier 300.

FIG. 2A is a top view of the calibrated air displacement pump 47 of FIG. 2.

FIG. 2B is a cross sectional view of the calibrated air displacement pump 47 of FIG. 2.

FIG. 3 is a side view of a fish waste water clarifier of the present invention. The clarifier 300 is the settling area to reduce velocity of water to allow for fish waste solids to settle to the bottom for later removal from the clarifier 300 for proper disposal.

FIG. 3A is a top view of the Clarifier of FIG. 3.

FIG. 4 is a side view of a fish tank and other components of the Modular Aquaponics System of the present invention. The fish tank 46 contains water, aquatic animals, aeration devices, heaters 53, and the calibrated air displacement pump 47 for removing fish waste from the fish tank 46 to send it to the clarifier 300.

FIG. 5 is a schematic of a control panel 70 of the present invention. The control panel is a centralized control system for timing the operation of the air pump to provide energy for lifting water through the calibrated air displacement pump 47.

FIG. 6 is an end view and a side view of a grow tray 600 of the present invention. The grow tray 600 is a waterproof table of six to eight inches in depth filled with ¾ inch gravel that allows for water to readily fill up and flow from the clarifier 300 through the grow tray 600 to provide nutrients and water to the growing plants 401.

FIG. 7 is a top view of a Modular Aquaponics System of the present invention. FIG. 7 depicts a design layout for the complete aquaponics system including grow tray 600, fish tank 46 and clarifier 300.

FIG. 8 is a top view of a snap together system the present invention. The snap together system incorporates all the elements of a modular grow tray (FIG. 7), using readily assembled plastic-components. This snap together system can be easily modified to adjust for size.

FIG. 9 is a side view of a snap together system of the present invention.

FIG. 10 is a side view of a snap together tray, fish tank 46 and clarifier 300 of the present invention.

FIG. 11 is a side view of a water flow diagram of the present invention. The water travels from the fish tank 46 by way of the calibrated air displacement pump 47 to the clarifier 300 through the overflow pipe 33, 37, 27, 26, 38 to the spreader 94 at the head of the grow tray 600. When the water reaches a level predetermined in the grow tray 600 the automatic trip valve assembly 48 releases the water to drain back into the fish tank 46.

### DETAILED DESCRIPTION OF THE INVENTION

### A. Overview

The Modular Aquaponics System of the present invention is comprised of three major components. As shown in FIGS. 4 and 7, these are: 1) a fish tank 46, 2) a plant grow tray 600, and 3) a water clarifier 300 for removing solid fish waste. These components are injection molded, roto-molded, fabricated from stock on site or combined with other materials which can be made waterproof. The fish tank 46 has a Calibrated Air Displacement (“CAD”) pump 47 to transfer fish waste and nutrient-rich water from the fish tank 46 to the clarifier 300. Solid fish waste settles in the clarifier 300; the nutrient-rich, clarified water travels out of the clarifier 300 via an overflow pipe 38 into a spreader 94 which evenly disperses the nutrient-rich water into the grow tray 600. Plants 401 in the grow tray 600 take up nitrogenous nutrients from the water. Cleaner water is therefore returned to the fish tank 46 by the action of a self-siphoning Automatic Trip Valve (“ATV”) assembly 48. In addition, the present invention includes “snap together” components permitting preassembled, ready-made sections to be joined into an aquaponics system on site.

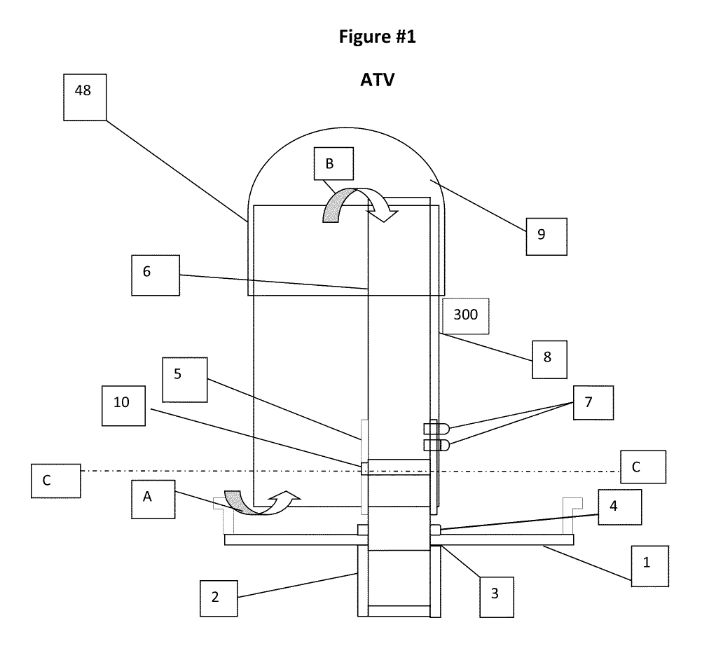

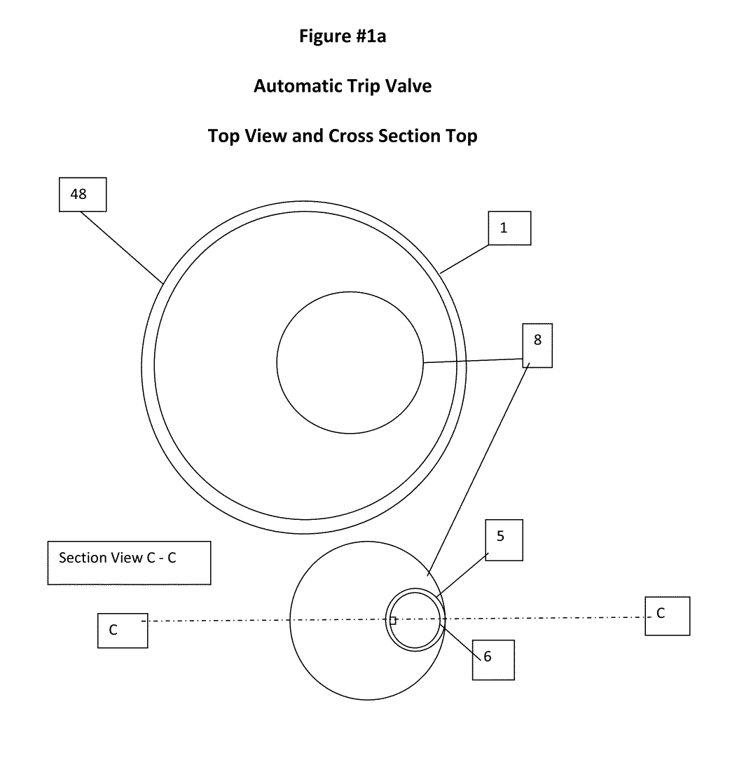

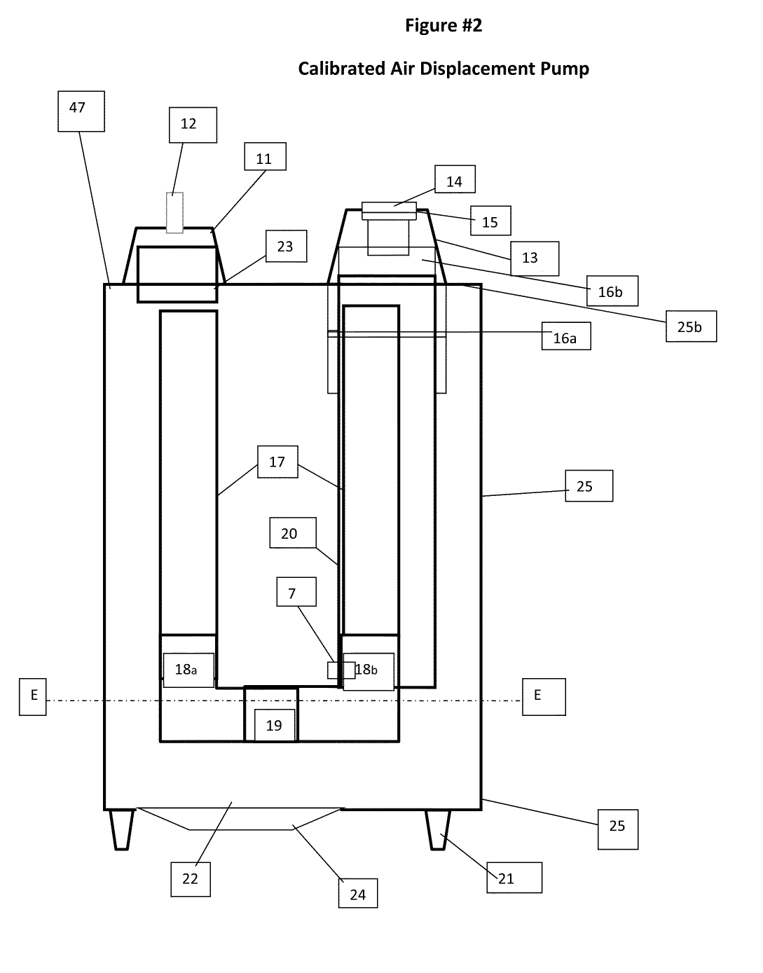

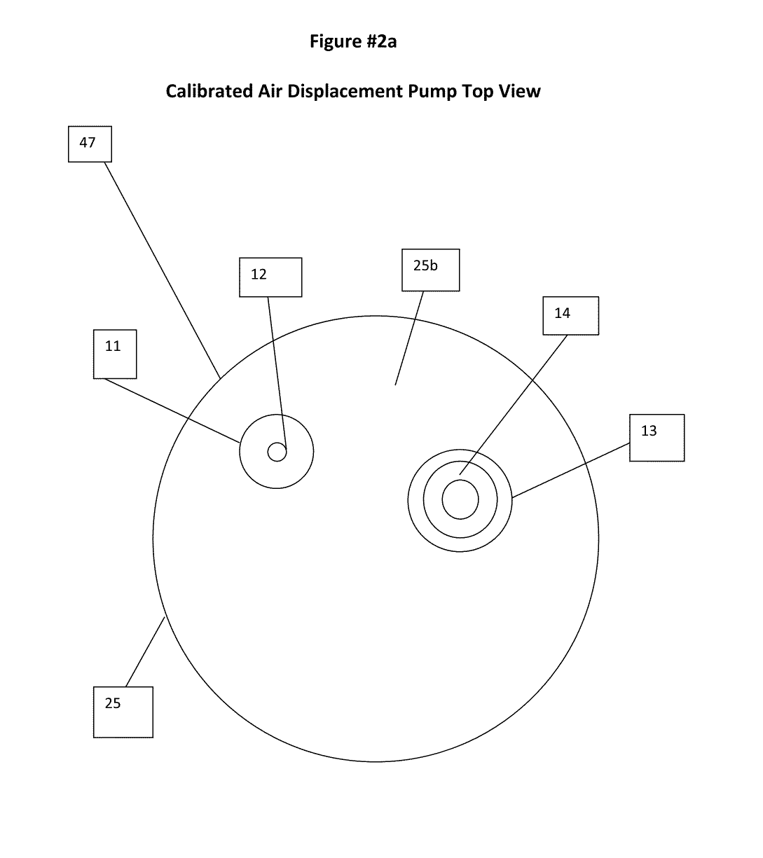

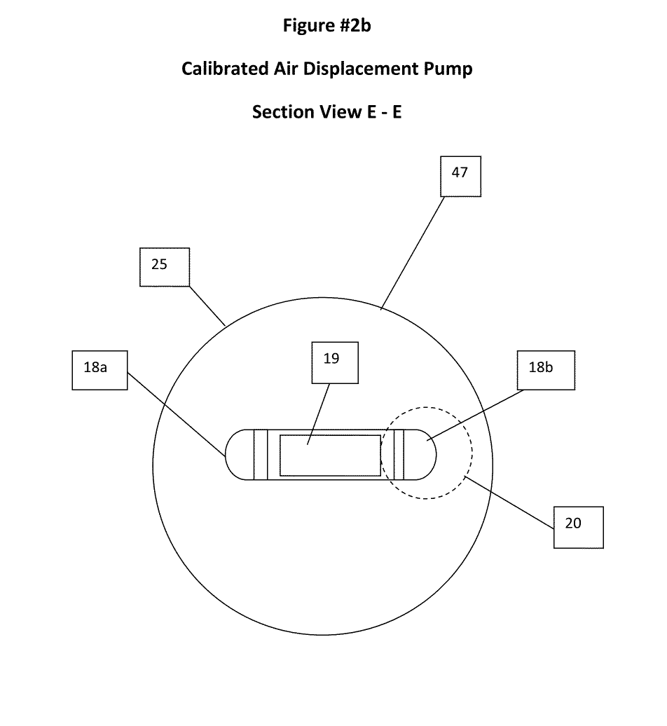

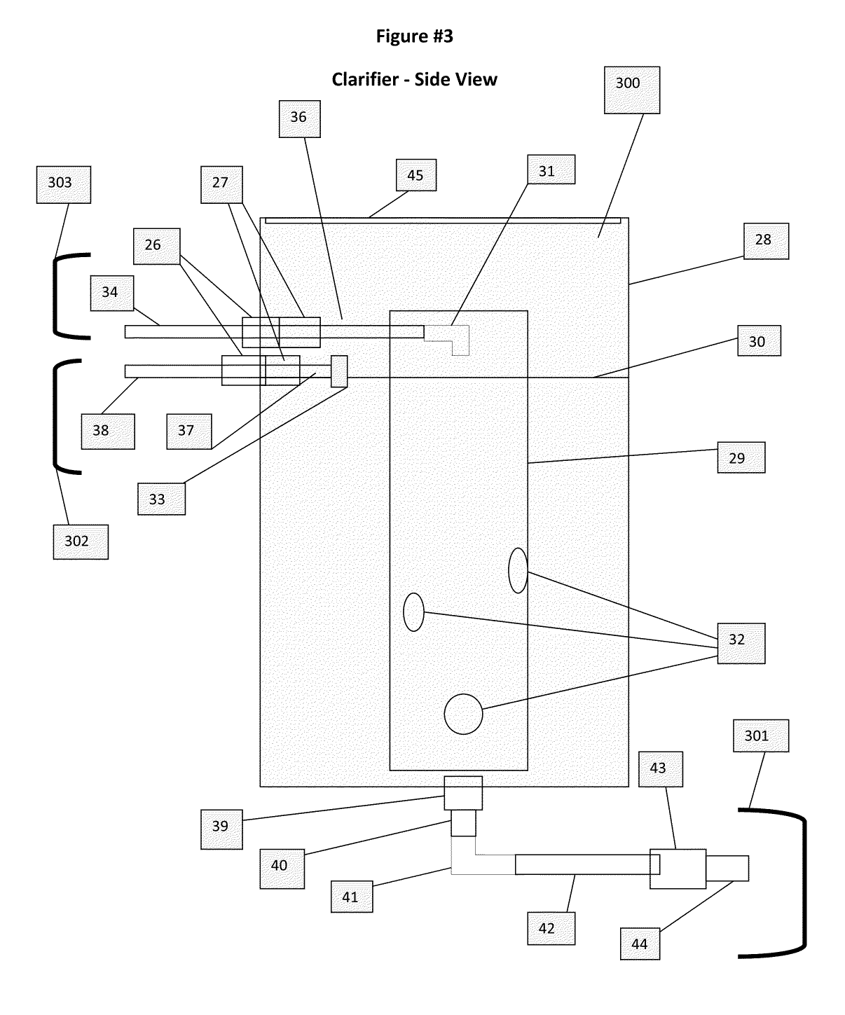

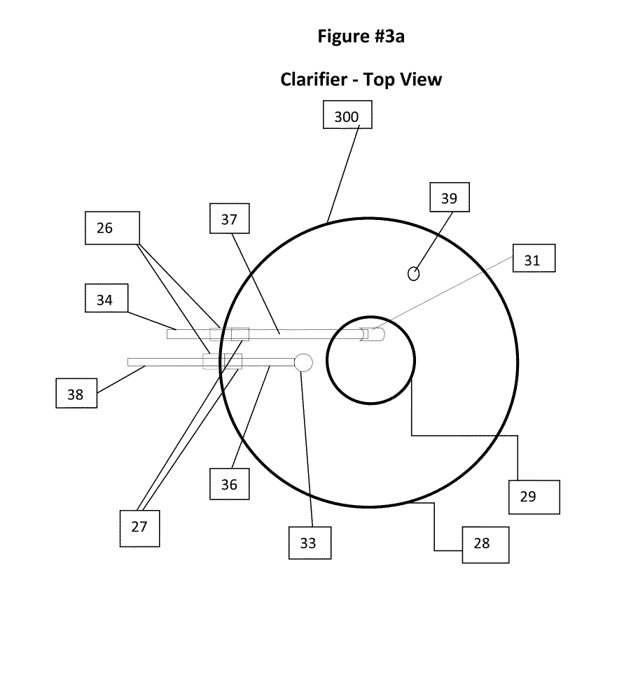

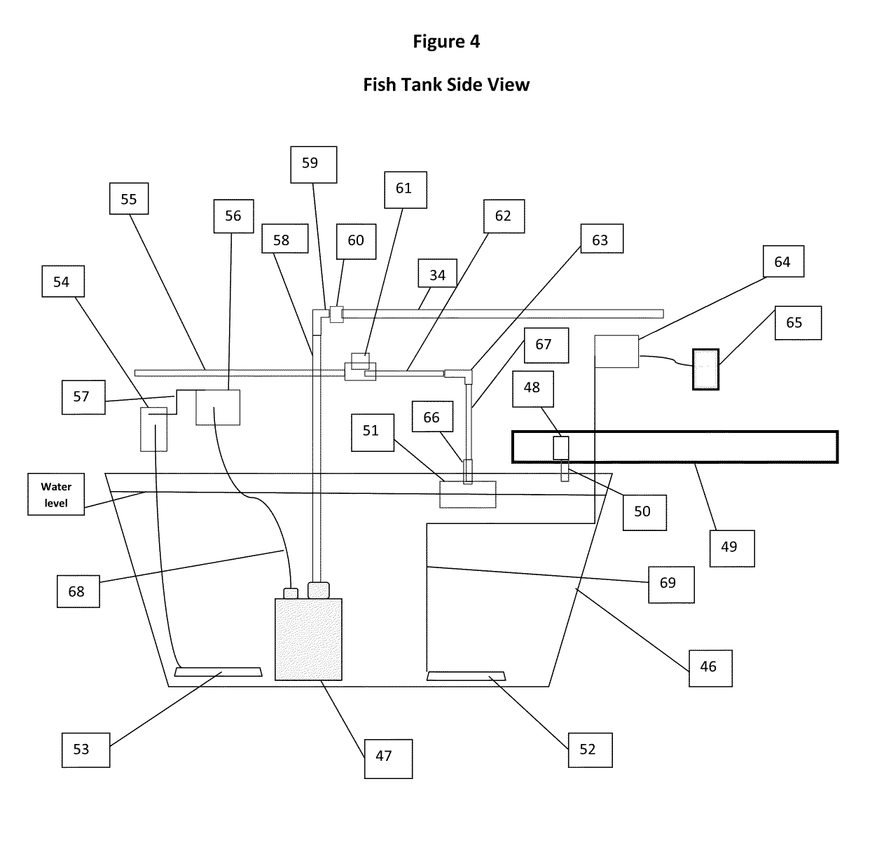

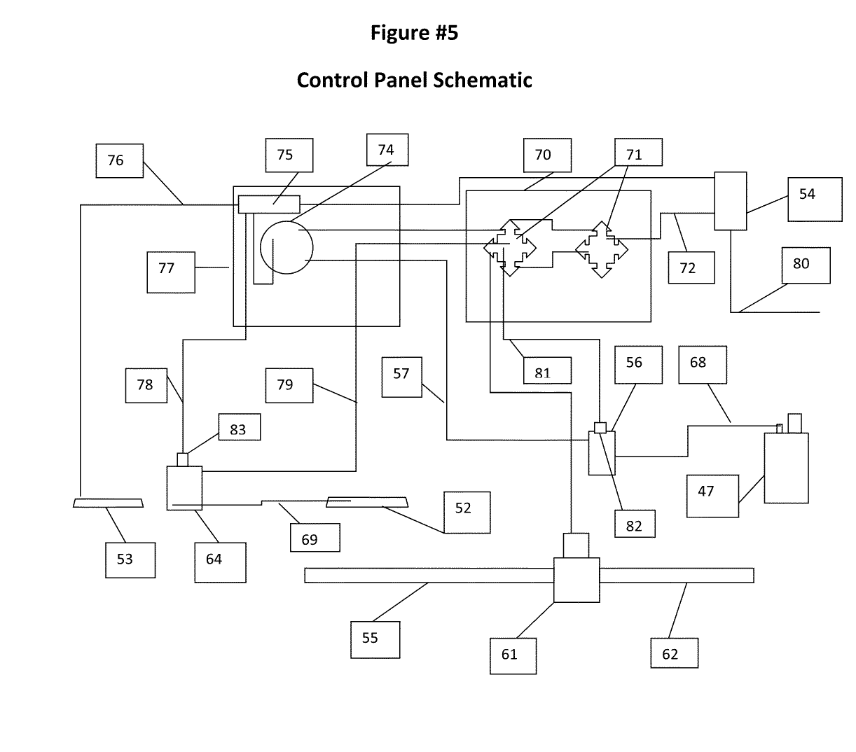

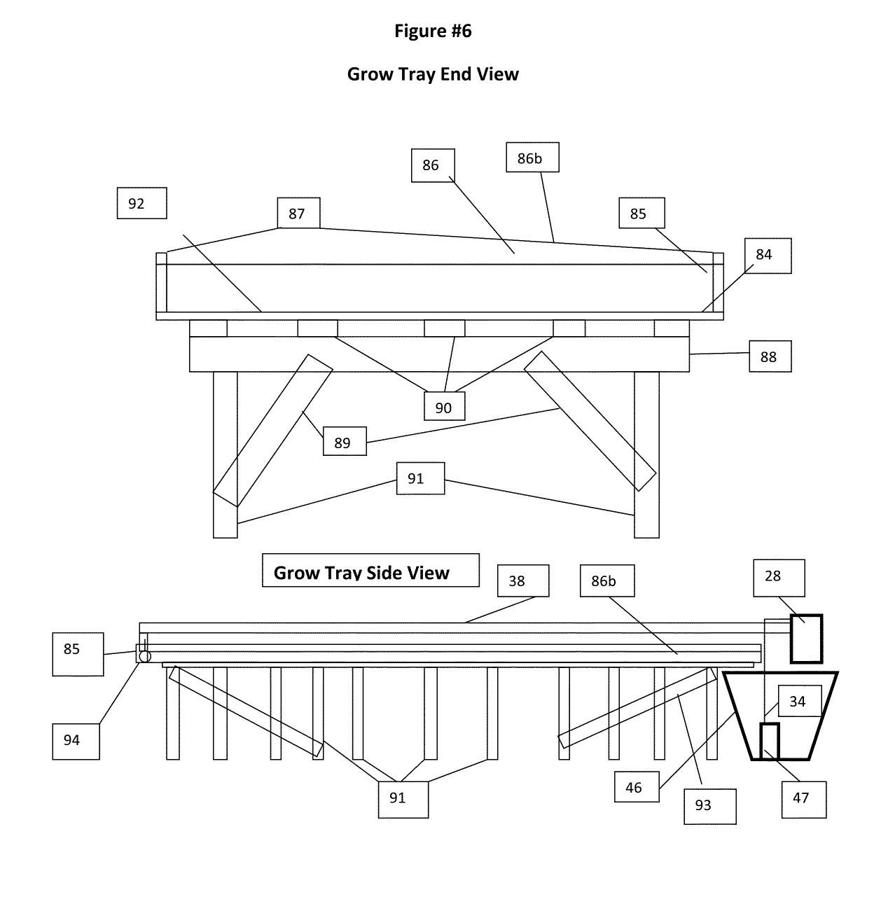

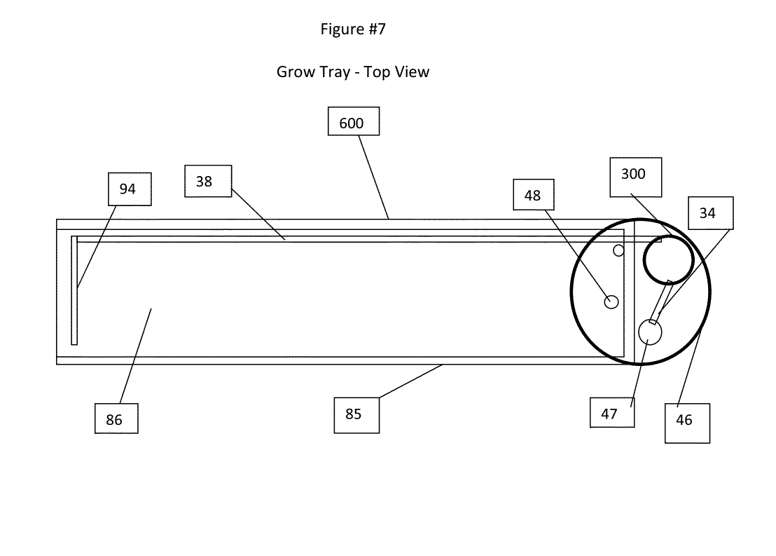

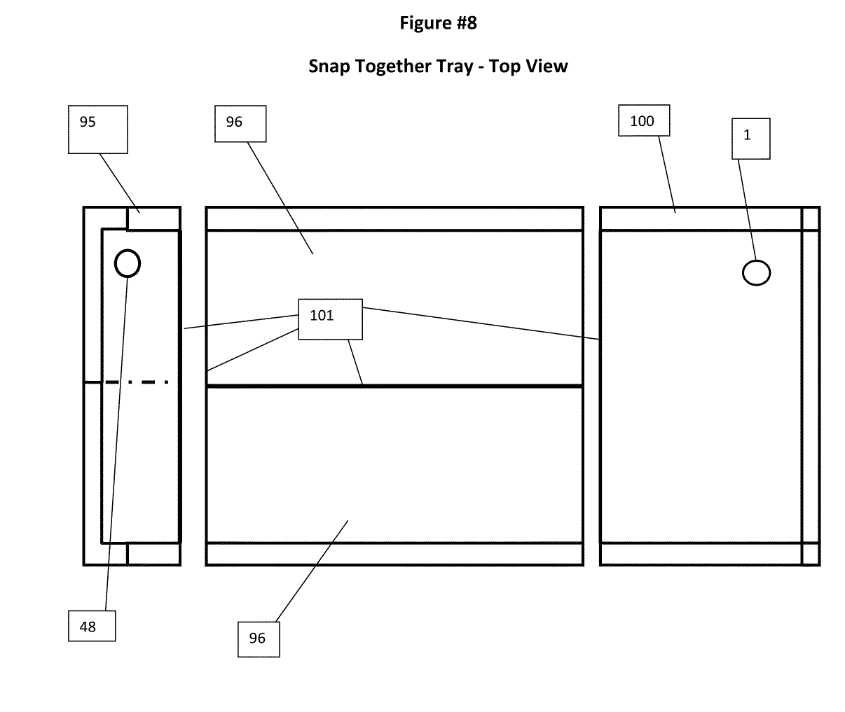

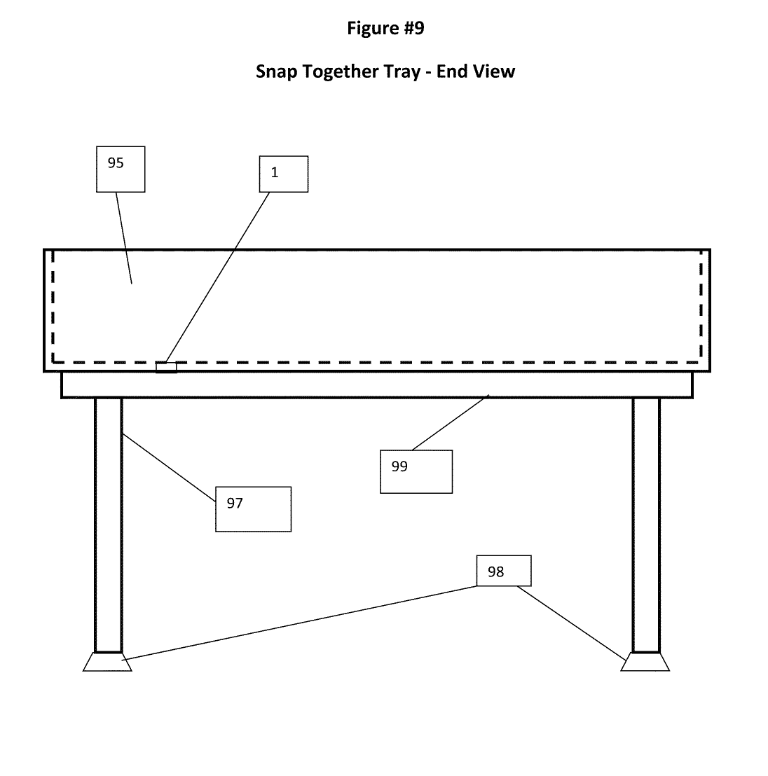

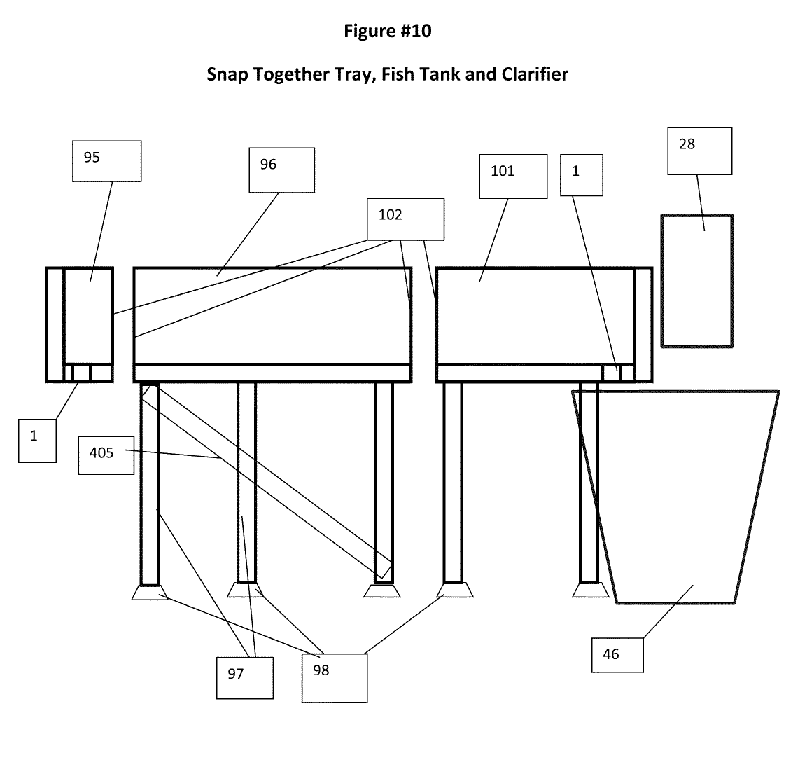

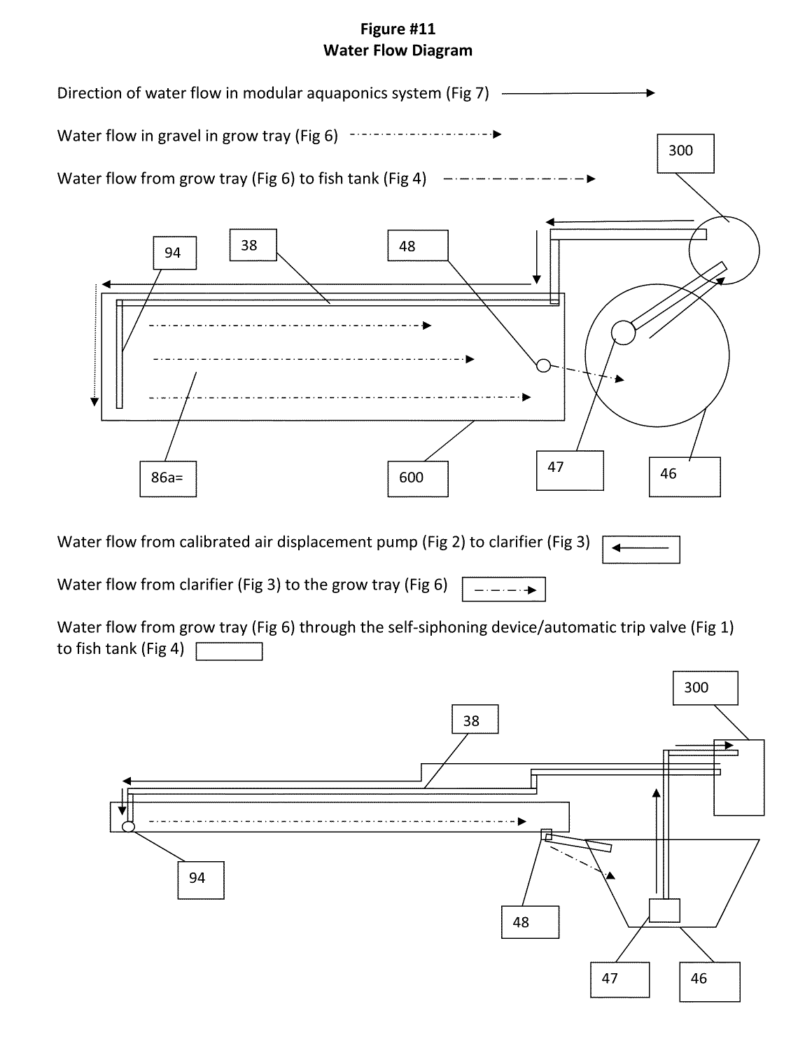

### B. Automatic Trip Valve (FIG. 1)

An automatic trip valve/self-siphoning assembly 48 is provided for conveniently draining water from the grow tray 600 upon the water in the tray reaching a predetermined level.

Details of the self-siphoning/automatic trip valve assembly are illustrated in FIG. 1. The threaded end of a one-half inch, white PVC male threaded fitting 2 is inserted in a suitable sized hole drilled through a 3-inch knock out 1 installed in the bottom of the lower end portion of the grow tray 600 for water to flow back into the fish tank 46 from the grow tray 600.

On each side of the threaded one-half inch, white PVC male threaded fitting 2 a one-half inch conduit nut 4 is fitted and sealed with type 1 silicone seal 3. The barrel of the self-siphoning/automatic trip valve assembly is a four inch length of one and one-half inch PVC schedule 40 pipe 8 which contains a one-half inch threaded female fitting 5 secured to a one-half inch thin-wall PVC pipe 6 secured with two three-sixteenth inch pop rivets 7, one passing through only the female fitting 5 and the one above it through the fitting and the half-inch thin wall PVC pipe 6. A three-eighths inch hole 10 is drilled through the one-half inch threaded female fitting 5 three-eighths of an inch from the bottom threaded female fitting 5 at the end of the fitting.

The height of the self-siphoning/automatic trip valve assembly 48 can be adjusted according to the depth of the grow tray 600 and height of the gravel 86b.

A self-siphoning/automatic trip valve assembly 48 is mounted in a hole drilled through a plastic knock out 1 mounted in a three inch opening in the bottom of the grow tray 600 which extends over the fish tank 46 (as shown in FIG. 4). The self-siphoning/automatic trip valve assembly 48 is configured to periodically drain the grow tray 600 sufficiently to expose the root system of the plants 401 to ambient air. The incorporation of the self-siphoning/automatic trip valve assembly 48 makes the Modular Aquaponics System much simpler, less expensive and more reliable than prior aquaponics systems that have used multiple water pumps or triggered valves to achieve ebb and flow of the nutrient filled water and thereby alternately submerge and aerate the plants roots. As shown in FIG. 4, the self-siphoning/automatic trip valve assembly 48 is preferably mounted in the end of the grow tray 600 over the fish tank 46 so that once the water gets to a level of four and one half inches in the grow tray 600, substantially all of the water in the grow tray 600 is drained back into the fish tank 46, thereby exposing the roots of the plants to ambient air.

### C. Calibrated Air Displacement (“CAD”) Pump FIG. 2

The Calibrated Air Displacement Pump 47, as shown in FIGS. 2, 2A and 2B, is an air-powered submersible water pumping system used to remove fish waste from the fish tank 46 to move it to the clarifier 300.

As shown in the Modular Aquaponics System overview of FIG. 4, the calibrated air displacement pump 47 is an air powered water pumping system that removes waste water from the bottom of the fish tank 46 and lifts it through a ½ inch Up-pipe 58, through a ½ inch 90 degree elbow 59, a ½ inch to one inch adapter 60 and into a 1″ diameter PVC pipe 34 and to the clarifier 300.

As detailed in FIG. 2, the calibrated air displacement pump 47 has a six inch PVC schedule 40 pipe 25a, 8 inches long, as the main barrel or chamber of the calibrated air displacement pump 47. The bottom plate 25c of the calibrated air displacement pump 47 is fabricated from ⅛ inch PVC flat stock, cut into a circle the exact diameter (approximately 6½ inches) of the barrel 25a, cemented to the bottom of the barrel 25a using heavy PVC cement and with a single 1⅞ inch hole placed 2½ inches from the edge of the bottom plate 25c to which a highly modified toilet bowl check/flapper valve 22 [Korky Universal Fit standard two inch Flapper Model. Manufactured by Levella Industries, Inc. Burlington, Wis.]. The toilet flapper skirt of a one and a half inch universal toilet tank flapper has been completely removed leaving only a small residual ridge around the center depression in the body of the flapper. The normal mounting apparatus has been completely removed leaving only a one half inch plastic projection on each side. The chain lift retention boss has been completely removed and the surface has been buffed to create a flat sealing surface for the valve. This highly modified valve is mounted upside down over the hole in the bottom of the calibrated air displacement pump 47 with two one-eighth inch by half inch pop rivets in the appropriate holes. This highly modified valve is protected with a molded cover made with one quarter inch mesh hardware cloth. The molded cover is designed to allow valve clearance and to prevent small fish being sucked into the calibrated air displacement pump 47. The bottom plate 25c also contains three half round legs 21 made of PVC stock that has been cut from an 8 inch PVC pipe and mounted flat side to the bottom plate 25c, using heavy PVC cement, placed equidistant around the diameter ¼ inch in from the edge of bottom plate 25c.

The top plate 25bof the calibrated air displacement pump 47 is fabricated from ⅛th inch PVC flat stock cut in a circle to the exact dimensions of the barrel 25a and cemented into place with heavy PVC cement. The top plate 25b has two holes drilled into it. One of the two holes is 2½ inches in diameter and is placed 1 inch from the outside edge of top plate 25b. This hole is configured for a two inch PVC end cap 13 in which a ½ inch×¾ inch PVC bushing 14 and the ¾ inch conduit nut 15 are mounted through a 1⅛ inch hole drilled through the top surface of end cap 13 (to be used for mounting the Up-pipe 58. The second of the two holes is 1⅜ inch diameter and placed 1½ inches from the edge of top plate 25b. This second hole is configured for a 1 inch end cap 11 containing a one-inch piece of one inch PVC 23 and a 5/16 inch brass air barb 12. The end cap 13 (FIG. 2a) is also cemented to a two inch section of two inch diameter PVC pipe 16a which passes through the 2½ inch hole in the top plate 25b and is cemented into a two inch union 16b. The two inch union 16b is also where a two inch section of up-pipe 20 is mounted inside barrel 25a (to create “the interior chamber up-pipe 20”). The 1 inch end cap 11 is cemented to the top surface of the top plate 25b with heavy PVC cement; a 1¼ inch section of 1 inch PVC pipe 23 is cemented into the 1 inch end cap 11, and this section of 1 inch PVC pipe 23 extends ⅛th inch into the main chamber of the calibrated air displacement pump 47.

Within the calibrated air displacement pump 47 is a “U-tube assembly” comprising three lengths of pipe and two elbows assembled as follows. The U-tube assembly has two equal lengths of ½ inch pipe 17 (as upright arms of the “U”) which fit into two ½-inch elbows (modified from standard off-the-shelf to reduce length) 18a and 18b, and which are solvent welded to a ½-inch pipe section 19 (forming the bottom of the “U”). The U-tube assembly is mounted with one of the ½ inch PVC pipes 17 and part of elbow 18b inside the interior chamber up-pipe 20, placed in a cut out made by removing a 1⅛ inch diameter half circle of material from the bottom edge of the interior chamber up-pipe 20. The U-tube assembly 17, 18a,18b, 19 is secured to the side wall of the interior chamber up-pipe 20 in the cut out with a ⅛ inch rivet 7 placed in a ⅛th inch hole drilled through the elbow 18b and the interior chamber up-pipe 20 and with heavy PVC cement.

The performance of the calibrated air displacement pump 47 can be modified through the use of different materials (ranging from stainless steel to ABS plastic, to other types of plastic and ferrous metals) used in the construction and design of the calibrated air displacement pump 47 based on water flow volume requirements. These 3 modifications include 1) increasing or decreasing the barrel 25a diameter, 2) increasing or decreasing the length of the barrel 25a, and/or 3) increasing or decreasing the air volume supplied from an air pump 56 similar or equivalent to Ecoair3 Commercial Pump distributed by Sunlight Supply, Inc.—Product 728455] to the air barb 12.

For example, an increase in diameter in the barrel 25a from 6 inches in diameter to 8 inches in diameter increases the volume of water which can be moved from the fish tank 46 to the clarifier 300 per pumping cycle.

### D. Clarifier FIGS. 3 and 3a

The clarifier 300 is the settling area to reduce velocity of water to allow for fish waste solids to settle to the bottom for later removal from the clarifier for proper disposal.

The clarifier 300 is a water holding tank 28, preferably a 30 to 55 gallon drum made of food grade plastic and preferably having a cone-shaped bottom. The clarifier 300 has a drain assembly, an overflow pipe assembly, and a baffle 29 to reduce the velocity of the water entering from the fish tank 46 allowing the solid fish waste from the fish tank 46 ample time to settle to the bottom of the clarifier 300. The drain assembly, overflow pipe assembly and baffle are described in more detail below.

Clarifier Drain Assembly 301: The solid fish waste that settles must be periodically drained through a drain assembly consisting of a drain fitting 39 (preferably a ¾ inch threaded male with conduit nut and silicone seal), a ¾ inch drain pipe section 40, an elbow 41, a ¾ inch diameter pipe 42, a manual shut-off valve 43, and a garden hose adaptor 44.

The drain assembly 301, is coupled through the bottom wall of the clarifier 300. The drain assembly 301 permits easy periodic cleaning of solid waste from the clarifier 300 that can be used on other agricultural plants outside the greenhouse (shrubs, flowers, vegetables, trees, etc.), or, the solid waste can be flushed into a sewer system, or otherwise disposed of in a sanitary fashion because it contains no toxic substances.

Clarifier Overflow Pipe Assembly 302 and Intake Pipe Assembly 303: The clarifier 300 has an overflow pipe assembly 302. The overflow pipe assembly 302 is coupled through the side wall 28 of the clarifier 300 through one inch PVC fittings comprise a 1 inch PVC T fitting 33 joined to a section of 1 inch of PVC pipe 37 [symbol] and 38 through a one inch threaded female fitting 27 and a one inch threaded male fitting 26 secured with type 1 silicone seal (not shown) and placed at a level one inch to three inches below the intake pipe assembly 303. The intake pipe assembly 303 comprises a 1 inch section of PVC pipe 34 to bring water into Clarifier 300 from fish tank 46, a one inch threaded female fitting 27 and a one inch threaded male fitting 26 secured with type 1 silicone seal (not shown) a 1 inch section of PVC pipe 36 fitted to a 1 inch 90 degree elbow 31. The overflow assembly 302 permits the water in the clarifier 300 to remain the same level regardless of the inflow from intake pipe assembly 303. This overflow pipe assembly 302 directs the water to the spreader 94 (FIGS. 6, 7 and 11) at the head of the grow tray 600.

The overflow pipe assembly 302 is placed at least 12 inches above the level of the grow tray 600 allowing gravity to move the ammonia- and dissolved waste-laden water to the grow tray 600. The clarifier 300 tank 28 is fitted with a tight fitting lid 45 which allows access for periodic cleaning. The clarifier 300 is normally placed in an insulated box for retaining the heated water flowing from the fish tank 46.

In tropical climates where the ambient temperature does not go below 60 degrees F., the insulation for the clarifier 300 is not necessary.

Clarifier Baffle: The clarifier 300 includes a vertically oriented cylindrical baffle 29, preferably having a diameter of about 6 inches, placed near the center of the holding tank 28 extending from the bottom of the holding tank 28 up to five inches below the surface of the lid 45 to create a turbulence break causing the water to slow its velocity. (FIGS. 3 and 3a.) The baffle 29 is made from a section of six-inch PVC pipe with four or five two- to three-inch holes 32 drilled on the lower half of the baffle 29.

The clarifier 300 holding tank 28 is preferably mounted in a vertical position inside an insulated box (not shown, and optional, depending upon climatic conditions of the system) placed above the fish tank 46 with the overflow pipe 38 at least 12 inches above the top of the grow tray 600. The inflow from the fish tank 46 through the up-pipe assembly 34, 26, 27, 36, 31, brings water through a one and a half inch hole drilled near the top of the baffle 29 to the inside edge of the baffle 29 and directed downward at a 45-degree angle through a 90-degree elbow 31. The transition from the one inch diameter pipe 36 to the six inch baffle 29 decreases the velocity of the water resulting in the fish waste solids settling to the bottom of the clarifier 300. The clarified water slowly rises in the clarifier drum 28 to a T-fitting 33 which prevents floating debris from being conveyed to the grow tray 600 through the overflow pipe assembly 302 to the spreader 94 located at the head of the grow tray 600 filling the grow tray 600 with nutrient rich water to a predetermined level regulated by the self-siphoning/automatic trip valve 48.

### E. Fish Tank and Modular Aquaponics System FIG. 4

FIG. 4 shows the majority of the components of the Modular Aquaponics System of the present invention. These components are the fish tank 46, which contains water, aquatic animals, aeration devices, heaters 53, and the CAD pump 47 for removing fish waste from the fish tank 46 to send it to the Clarifier 300. Water leaves the clarifier 300 and enters the grow tray 600. The water flows into the grow tray 600 to a predetermined height at which time the self-siphoning automatic trip valve 48 permits the water to return through pipe 50 to the fish tank 46 completing the loop in the system.

The fish tank 46 can be a plastic livestock watering trough of appropriate size or concrete enclosure based on a formula relating to grow tray 600 area and gallons of water per fish. This type of fish tank 46 is generally available at feed and grain stores, some hardware stores and online distributors specializing in livestock. The concrete fish tanks 46 are fabricated onsite using concrete blocks or concrete forms to create the appropriately sized fish tanks 46 based on the formula below.

The preferred stocking rate of fish-to-grow-space formula is: For each square foot of grow tray 600, two gallons of water are required. The stocking ratio of fish-to-water should never exceed one fish per gallon of water. The number of fish in the fish tank 46 should never exceed twice the number of square feet in the grow tray 600 regardless of the actual fish tank 46 size. For example, a commercial grow tray 600 containing 200 square feet of grow space will require a 400 gallon fish tank 46 into which 400 fish can be placed. Similarly, a grow tray 600 containing 100 square feet of grow space will require a 200 gallon fish tank 46 into which 200 fish may be placed.

The Modular Aquaponics System (FIG. 4) is designed for use with warm water, fresh water aquatic animals only which thrive best in 78 to 80 degree F. water temperatures. The Modular Aquaponics System (FIG. 4) works best with California Hybrid Tilapia, an all-male result from a crossbreed of Mossambica and Hornorum tilapia.

A covering 402 of netting, chicken wire or other material is required on the top of the fish tank 46 to keep the fish from jumping out of the fish tank 46.

The fish tank 46 contains two air wands 52 to provide aeration for the health of the fish and are supplied with air forced through air tubing 69 from the 35 liter per minute air pump 64.

The fish tank 46 also contains the calibrated air displacement pump 47. The calibrated air displacement pump 47 is an air powered water pumping system used to remove the waste water from the bottom of the fish tank 46 and lift it through a ½ inch Up-pipe 58, through a ½ inch 90 degree elbow 59, a ½ inch to one inch adapter 60 and into a 1″ diameter PVC pipe 34 and to the clarifier 300.

The fish tank 46 may also contain aquarium heaters 53 to maintain the temperature for maximum growth and health of the fish, between 78 degrees and 80 degrees F.

Automatic Water Leveling Components: Because of normal water usage by the plants (transpiration), a certain amount of makeup water is required each day to maintain the water level in the fish tank 46 and for the calibrated air displacement pump 47 to work correctly. The automatic water leveling components are comprised of an automatic float water level device 51, which is attached to an adaptor ½ inch to ¾ inch hose fitting 66, which connects to a section of ½ inch pipe 67, which in turn connects to a ½ inch 90 degree elbow 63; the elbow is joined to another section of ½ inch pipe 62 a 24 volt valve control 61, controls the amount of water that travels through the ½ inch make up water pipe 55. This component arrangement may be modified but as shown it works well and maintains a predetermined water level in the fish tank of two inches or more below the rim of the fish tank 46 by adding water only during a period of four minutes per day (for example, at approximately 5:00 AM) when the water in the fish tank 46 is at its maximum height. This prevents the fish tank 46 from overflowing during normal cycling. The timing for the additional water to be added to the fish tank 46 is regulated by the control system (FIG. 5) and a 24-volt water shut off valve 61.

When the fish tank 46 is placed in an insulated box, that box is preferably provided with a hinged lid for the operator to feed and harvest the fish. This lid preferably includes a clear transparent window that covers half the exposed top (the portion extending from under the grow tray 600 of the fish tank 46 to allow ambient light into the fish tank 46 for the benefit of the fish, to allow them to receive light in the fish tank 46 and also allow operators to observe them without having to open the lid of the fish tank 46.

In climates requiring the fish tank 46 to be insulated to maintain a temperate of 78 to 80° F., the fish tank 46 is placed in an insulated box. Rigid foam insulation (e.g. Bead board or Styrofoam) is generally placed on the inside of a plywood box built to house the fish tank 46. The insulation is also included in the lid (not the window) and cover assembly.

Depending on the climate where the aquaponics system is located, and the type of aquatic animals being raised, it may be necessary to maintain the temperature of the water in the fish tank 46 with submersible electric aquarium heaters 53 or other devices (e.g. Solar heating, etc.).

The more effective the insulation, the easier it is to maintain a consistent temperature of the water in the fish tank 46. The thermal insulation reduces the energy costs otherwise incurred in heating the water. The temperature range for best overall production and least stress of aquatic animals is between about 78 to 80 degrees F. In this restricted temperature range, the fish eat the greatest amount of food and convert it to protein with little or no stress. If the temperature is too high, the oxygen requirements go up dramatically, and if the temperature is too low, the fish slow down and do not convert food into protein efficiently.

Possible variations of the fish tanks 46 are the size and shape depending on the size of the grow tray 600 and number of fish required in the modular aquaponic system as described in the formula above. The material for the fish tank 46 can be made of plastic, concrete or a plastic lined wooden structure. Formed plastic fish tanks 46 can be molded to conform to the space available under the grow tray 600 and can be made strong enough to support the clarifier 300.

### F. Control System FIG. 5

The present invention includes a centralized control system 70 for timing the operation of the air pump to provide energy for lifting water through the calibrated air displacement pump 47.

The timer 74 is connected to a 65 liter per minute air pump 56 (FIG. 4) by an electrical cord 57, controlling its function of supplying air through the tubing 68 to the calibrated air displacement pump 47 on a timed basis. This time can vary from one hour, twice per day, to an hour or more, twice or more per day, depending on conditions dictated by temperature, humidity, and plant size and variety.

The aquarium heaters 53 (FIG. 4) which are internally thermostatically controlled to maintain a water temperature in the fish tank between 78 and 80 degrees F. are connected to the buss bar 75 through the cord 76. The buss bar 75 also supplies constant power to the small air pump 64 (FIG. 4).

The water valve control 61 (FIG. 4) is also controlled by the controller boards 71 and is programmed, for example, to operate four minutes per day at 5:00 AM to add water to the fish tank 46 to maintain the predetermined water level in the fish tank 46 of two to three inches below the rim of the fish tank 46.

A motion sensor 83 and a heat sensor 82 are connected through sensor wires 81 and 79 and the power line 78 to the controller board 71 to monitor the heat or movement or lack thereof in air pump 64 (FIG. 4) and air pump 56.

There are a wide variety of functions the operator may choose to monitor in the control system (FIG. 5) such as pH level in fish tank 46, temperature in fish tank 46, temperature in the structure, air pump functionality, and water level in the fish tank 46.

### G. Grow Tray FIG. 6

A grow tray 600 is a waterproof table, preferably six to eight inches in depth and filled with ¾ inch gravel that allows for water to readily fill up and flow from the clarifier 300 through the grow tray 600 to provide nutrients and water to the growing plants. This process also removes nutrients from the water to be absorbed by the plants which also helps purify and re-oxygenate the water before returning to the fish tank.

The grow tray 600 is shown rectangular in shape. The grow tray 600 can be built with available materials (lumber or concrete). The grow tray 600 is configurable in terms of available space, the height above the fish tank 46 to allow gravity flow of the water from the clarifier 300 and back to the fish tank 46 and may be sized to the available space. The grow tray 600 is generally five to six feet wide and from 8 feet to 40 feet in length. The depth of the grow tray 600 is conveniently determined by the either the width of commercial 2 feet×6 feet lumber used for the side walls or other materials to create a working depth of five and a half inches.

If the grow tray 600 is made from lumber, it requires a waterproof pond liner material 92 that covers the entire length of the grow tray 600 including the plywood base 84, side walls 95 and end walls 85 with enough left over to secure the pond liner 92 with wood retainers 87.

The only opening in the bottom of the grow tray 600 is a single 3 inch knock out 1 for mounting the self-siphoning automatic trip valve 48. This knockout 1 is carefully installed and waterproofed over the pipe 50 above the fish tank area allowing the water to drain directly back into the fish tank 46 after the grow tray 600 has been filled to its predetermined level (by the automatic trip valve 48.

The wooden grow tray 600 is supported by legs 91 and stringers 90 with a cross beam 88 and brace 89, which may be constructed with two by four inch lumber pieces firmly secured together with wood screws, nails or the like. The legs 91 holding the grow tray 600 may be adjusted to a desirable length to place the grow tray 600 at a convenient height for manual tending of the plants; this is preferably normal counter height of 36 inches, but more importantly, should provide the desired state of level in grow tray 600 so that water does not pool at one end. The legs 91 supporting the grow tray 600 are preferably placed on four foot or less centers because the grow tray 600 plus the weight of the gravel and water make the grow tray 600 extremely heavy. The placement of the legs on four foot or less centers prevents the grow tray 600 from bellying and producing dead spots that can affect plant growth.

The water flowing into the grow tray 600 rises its entire length at the same time, similar to filling a bath tub. There is preferably no noticeable slope or difference in the height of the water from one end of the tray to the other. Water seeks its own level and the water in the grow tray 600 rises from the water from the clarifier 300 through the spreader 94 and then lowers as the water drains out of the grow tray 600 and back into the fish tank 46.

Because of the Modular Aquaponics System grow tray 600 design there is no need to ever clean the gravel 86b once it has been installed in the grow tray 600.

The height of the grow tray 600 can be adjusted using leg adjusters 98 (FIGS. 8-10) to ensure clearance above the fish tank 46 and to adjust for unevenness in the floor or ground.

The length and width of the grow tray 600 can be adjusted as can the construction materials.

With the use of concrete, the legs 91 are designed differently and can be on centers much further apart. When using concrete for the grow tray 600, a slight belly across bottom of the side to side dimension is desirable to allow for complete drainage. The concrete grow tray 600 must be level end to end.

The working depth of the grow tray 600 must preferably remain between five and a half and six and a half inches to work correctly.

The length and width of the grow tray 600 can be adjusted as can the construction materials.

### H. Modular Aquaponics System FIG. 7

FIG. 7 depicts a design layout for the complete aquaponics system including grow tray 600, fish tank 46 and clarifier 300. Not shown are connectors, air pumps and control systems, which are discussed in more detail with respect to FIGS. 1-6.

The Modular Aquaponics System in FIG. 7 uses an easy-to-build modularized construction system that can be assembled with local materials (such as lumber, concrete, gravel and PVC) by local builders or carpenters who construct the grow tray 600, fish tank 46, clarifier 300, and add the components for proper water flow and aeration: automatic trip valve 48, a calibrated air displacement pump 47, and a control system (FIG. 5). After the system has had water flowing for 24 to 48 hours from the fish tank 46 through the clarifier 300 through the grow tray 600 and returning to the fish tank 46, aquatic animals can be introduced into the fish tank 46 and seedling plants can be planted in the grow tray 600. The operator can expect to harvest food approximately 40 days after the system has become operational.

The fish tank 46 is where the water for the system resides most of the time, and which contains the aquatic animals. It can be made of a plastic livestock watering trough of appropriate size or built as a concrete structure based on a formula relating to grow tray area and gallons of water per fish, as described elsewhere herein. When the fish tank 46 is made of concrete, it may be fabricated onsite using concrete blocks or concrete forms to create the appropriate sized fish tanks 46.

The water in the fish tank 46 is lifted out of the fish tank 46 by the calibrated air displacement pump 47 which is an air powered water pumping system used to remove the waste water from the bottom of the fish tank 46 and transported into the clarifier 300.

The only opening in the bottom of the grow tray 600 is a single three inch hole where the knock out 1 for mounting the self-siphoning automatic trip valve 48. The water flow path is from the fish tank 46 to the clarifier 300, to the head of grow tray 600 through a spreader 94 placed under the gravel 86b to fill the grow tray 600 to the predetermined level and back into the fish tank 46. The grow tray 600 is level in both directions across its entirety.

The calibrated air displacement pump 47 and the automatic trip valve 48 are generally prefabricated off site and provided as complete, working assemblies to insure quality control in the field.

The connecting conduit pipes are generally PVC pipe, but can be made of any material that is non-toxic to fish and plants. The control system 70 can be as simple as a power strip similar to buss bar 75 with an analogue 24-hour timer 74 to a completely automated control and monitoring system 74 housed in a control center 70 and provided with backup power and remote monitor and control capability.

The clarifier 300 (See also FIG. 3) can be as simple as a 30 to 55 gallon plastic food grade drum 28 or as complex as a custom made roto-molded cone bottom tank with internally secured baffle 29 and inflow 26, 27, 37, 31 and overflow pipe 33, 36, 27, 26, all molded in place.

### Snap Together Grow Tray Top View (FIG. 8)

Incorporates all the elements (above) of a modular grow tray 600, readily assembled using plastic-components. The snap together grow tray may be easily modified to adjust for size.

The snap together grow tray (FIG. 8) is comprised of three basic components which are injection molded or fabricated from stock on site or combined with other materials which can be made waterproof. The snap together grow tray consists of three separate pieces: an end panel 95 with a mounting hole for an automatic trip valve/self-siphoning assembly 48, a reversible center section 96, a long end section 100 with an ATV mounting hole 1 which are snapped together at waterproofed spline joints to form a snap together grow tray varying in length from 10 feet to 42 feet. The width is generally 6 feet wide but can be reduced to 5 feet wide through special order.

The short tray end panel 95 of the snap together Modular Aquaponics System (FIG. 8, 9, 10) is five to six feet wide with a depth of six and a half to nine inches and side walls extending ten to twelve inches into the snap together grow tray area (length) with a splined waterproofed joint on the open end where the center tray 96 consisting of two parts that are exactly the same are mounted through the joint 101 of the snap together grow tray and placed against the end piece 95 with a spline 101 attach.

In summary, the center section 96 of the snap together grow tray consists of two separate pieces six feet long that are identical and interchangeable. They are assembled with the spline 101 and aligned to fit into the short end tray 95 on one end and the long-end tray 100 on the other end. Multiple sections of the center section 96 may be assembled to create a longer snap together grow tray to most effectively utilize the space available.

The center tray section 96 can be repeated six times resulting in a snap together grow tray 42 feet in length. The long end-tray 100 of the snap together Modular Aquaponics System (FIG. 8, 9, 10) is six feet wide and having a depth of six and a half inches and side walls extending 24 to 36 inches into the tray area (length) with a splined waterproofed joint 101 on the open end where the center tray 96 of the snap together grow tray is placed against the end piece 100 with a spline 101 attachment.

The width can vary from four to six feet depending on client specifications. The leg heights can be adjusted within a narrow range depending on the height of the fish tank 46 and clearance required for the snap together grow tray.

### I. Snap Together Grow Tray End View FIG. 9

End View of the Snap Together Grow Tray as indicated in FIG. 8.

The snap together grow tray, end view (FIG. 9) is comprised of four basic components which are injection molded or fabricated from stock on site or combined with other materials which can be made waterproofed. The width is generally 6 feet wide but can be reduced to 5 feet wide through special order. The snap together grow tray end view (FIG. 9) shows the three separate pieces (95, 96, 100).

The structures 97, 99, 98 that support the snap together grow tray end view (FIG. 9) are molded legs 97, 98 and a crossbeam 99 placed on 3 to 4 foot centers to assure the snap together grow tray (FIG. 8) level is maintained in both directions. Leg levelers 98 are included to compensate for uneven floor surfaces. The leg 97 and crossbeam 99 structures are designed to snap into the center section 96 of the grow tray (FIG. 8) in such a way that the increased pressure increases the stability of the snap together Modular Aquaponics System (FIG. 8, 9, 10).

The length of the snap together grow tray (FIG. 9) can vary from 10 feet to 42 feet and the width can vary from four to six feet depending on client specifications. The leg heights can be adjusted within a narrow range depending on the height of the fish tank 46 and clearance required for the snap together grow tray (FIG. 8) and the braces 405 can be placed to insure maximum stability of the snap together grow tray (FIG. 9).

### J. Snap Together Grow Tray, Fish Tank And Clarifier FIG. 10

The snap together Modular Aquaponics System (FIG. 8, 9, 10) is comprised of three basic components: 1) fish tank 46, 2) grow tray, and 3) clarifier 28 which are injection molded, roto-molded, or fabricated from stock on site or combined with other materials which can be made waterproof. The snap together Modular Aquaponics System (FIG. 10) consists of a grow tray fish tank 46 and clarifier 300 and which are the three major components of the modular aquaponic system (FIG. 8) and lend themselves to alternative fabrication methods and materials. This snap together Modular Aquaponics System (FIG. 10) still requires the technology components of the control system 70, automatic trip valve 48, calibrated air displacement pump 47 and connecting devices as shown in numbered sub-elements in FIGS. 1 through 8 in order to function properly for growing healthy plants and fish.

The snap together Modular Aquaponics System (FIG. 8, 9, 10) is prefabricated in factories for easy shipping to and installation in any location in the world. The snap together Modular Aquaponics System (FIG. 8, 9, 10) ensures high quality control, consistency in design and ease of assembly and installation. The snap together Modular Aquaponics System (FIG. 8, 9, 10) is designed to be assembled using local semi-skilled labor with minimal use of tools and materials.

Success in assembly is enhanced by the use of waterproof sealing materials and assembly jigs to ensure stability, water flow characteristics and to guarantee the success of the system for growing plants and aquatic animals.

The snap together Modular Aquaponics System (FIG. 8, 9, 10) differs from the current state of technology which uses wood, cement, pond liners and plastic drums comprising the various elements and requiring field assembly of the system utilizing local materials and labor.

The fish tank 46 capacity can be sized according to the volume of the grow tray (FIG. 8, 9, 10) according to the formula described elsewhere herein. The size of the clarifier 300 can be adjusted according to the size of the fish tank 46.

The materials used in the snap together Modular Aquaponics System (FIG. 8, 9, 10) must be food grade and may include ABS plastic, polycarbonate, fiberglass, or other plastic type materials or any combination thereof as conditions or specifications require.

### K. Water Flow Diagram FIG. 11

The water travels from the fish tank 46 by way of the calibrated air displacement pump 47 to the clarifier 300 through the overflow pipe 33, 37, 27, 26, 38 to the spreader 94 at the head of the grow tray 600. When the water reaches a level predetermined by the automatic trip valve assembly 48, it drains back into the fish tank 46.

Lifting the water from the fish tank 46 to the clarifier 300 with the calibrated air displacement pump 47 through the use of an air pump 56 is the only time energy is required to move the water in the Modular Aquaponics System (FIG. 7), the rest of the water flow is gravity powered.

The size of the grow tray 600, fish tank 46 and clarifier 300 are all adjustable depending on the requirements of the installation.

### L. Snap Together of Main Elements of the Invention

To simplify the assembly and reduce the need for sourcing of local materials for building a Modular Aquaponics System (FIG. 7), the prefabricated snap-together Modular Aquaponics System (FIG. 8, 9, 10) offers a standardized complete component based system that can be custom ordered, based on client needs, and shipped anywhere in the world for assembly and operation by semi-skilled labor.

The snap together Modular Aquaponics System (FIG. 8, 9, 10) components are designed to be palletized for shipping through conventional carriers (air freight, shipping containers or trucks) to any area in the world. The shipment can also include solar power systems, potable water systems, electrical generators, starter medium and seeds to any area requiring food.

### M. Alternative Embodiments of Invention

Modular aquaponic system (FIG. 7).

The modular aquaponic system (FIG. 8) can be constructed of concrete or plastic in its entirety. It can also be made from components which are injection molded, roto-molded, fabricated from stock on site or combined with other materials which can be made waterproof.

The calibrated air displacement pump 47 and the automatic trip valve assembly 48 are generally fabricated off site to insure quality control.

The connecting conduit pipes are generally PVC pipe, but can be made of any material that is non-toxic to fish and plants. The control system 70 can be as simple as a power strip similar to buss bar 75 with an analogue 24-hour timer 74 to a completely automated control and monitoring system (FIG. 5) housed in a control center 70 and provided with backup power and remote monitor and control capability.

Snap Together Grow Tray—End View (FIG. 8).

The width can vary from four to six feet depending on client specifications. The leg heights can be adjusted within a narrow range depending on the height of the fish tank 46 and clearance required for the grow tray.

Snap Together Grow tray—Top View (FIG. 9).

The length of the grow tray can vary from 10 feet to 42 feed and the width can vary from four to six feet depending on client specifications. The leg heights can be adjusted within a narrow range depending on the height of the fish tank 46 and clearance required for the grow tray (FIG. 7) and the braces can be placed to insure maximum stability of the grow tray.

Snap Together Grow Tray, Fish Tank and Clarifier—Side View (FIG. 10).

The length of the grow tray can vary from 10 feet to 42 feed and the width can vary from four to six feet depending on client specifications. The leg height can be adjusted within a narrow range depending on the height of the fish tank 46 and clearance required for the grow tray and the braces can be placed to insure maximum stability of the grow tray. The location of the clarifier 300 the fish tank 46 and the control panel 70 can vary depending on the space available and the requirements of the client.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

1. A system for conveying water for growing edible plants and aquatic animals comprising by means of:
a. a fish tank containing water and aquatic animals, and aeration devices and said fish tank covered with exterior insulation for fish health
b. a submerged water pump for moving said water containing fish effluent and solid waste from said fish tank said water pump operates by applying air pressure periodically to said water pump
c. a water settling device for separating said water and said fish effluent from said solid waste said water settling device contains a perforated baffle for reducing water velocity said water settling device accumulates said solid waste for removal from said device
d. a transport device for moving said fish effluent from said water settling device, and conveying said water containing said fish affluent to a grow tray
e. said grow tray containing medium for growing said plants said grow tray constructed of a variety of materials said grow tray varies in size
f. an automatic valve device for regulating water level in said grow tray said automatic valve device is preset for said water level in said grow tray.
